(19) United States
(12) Patent Application Publication
(10) Pub. No.: US 2018/0213977 A1
(43) Pub. Date: Aug. 2, 2018

(54) METHOD FOR PREPARING A PREPARATION ITEM BY MEANS OF AN ELECTRICALLY OPERATED FOOD PROCESSOR

(71) Applicant: Vorwerk & Co. Interholding GmbH, Wuppertal (DE)

(72) Inventor: Michael SICKERT, Ennepetal (DE)

(73) Assignee: Vorwerk & Co. Interholding GmbH, Wuppertal (DE)

(21) Appl. No.: 15/881,913

(22) Filed: Jan. 29, 2018

(30) Foreign Application Priority Data
Jan. 30, 2017 (EP) 17153703.8

(51) Int. Cl. A47J 43/07; A47J 36/32

(52) U.S. Cl. CPC A47J 43/0716; A47J 36/32

(57) ABSTRACT

The invention relates to a method for preparing a preparation item (2) by means of an electrically operated food processor (1), wherein a user of the food processor (1) introduces a preparation item (2) into a preparation vessel (3) of the food processor (1), and transmits preparation instructions to a control device of the of the food processor (1) via a touchscreen (4), and wherein the food processor (1), depending on the preparation instructions, automatically performs a preparation step and/or adjusts preparation parameters for preparing the preparation item (2). In order to make preparing a preparation item (2) even more comfortable, it is proposed that, before the preparation item (2) is introduced into the preparation vessel (3), the user hold it in front of the touchscreen (4) with a holding means (5) in such a way that the holding means (5) touches at least a partial area of the touchscreen, wherein a dimension of the held preparation item (2) is ascertained based on the position of the touched partial area on the touchscreen (4).

### AREA OF TECHNOLOGY

The invention relates to a method for preparing a preparation item by means of an electrically operated food processor, wherein a user of the food processor introduces a preparation item into a preparation vessel of the food processor, and transmits preparation instructions to a control device of the food processor via a touchscreen, and wherein the food processor, depending on the preparation instructions, automatically performs a preparation step and/or adjusts preparation parameters for preparing the preparation item.

### PRIOR ART

Electrically operated food processors, with which preparation items can be prepared, are designed as floor-mounted appliances with a preparation vessel, for example, wherein an agitator for comminuting and mixing the preparation item is arranged inside of the preparation vessel, and a heating device for the preparation item is also allocated to the preparation vessel. Food processors of this kind are used in particular for independently, automatically executing preparation steps of a recipe with preferably a plurality of preparation steps and/or preparation parameters, wherein preparation parameters such as a temperature, agitator speed, preparation time and the like are programmatically set, for example.

For example, publication WO 2011/069833 A1 discloses a food processor with an agitator vessel and an agitator located in the agitator vessel, wherein the food processor has a touchscreen for receiving preparation instructions from a user. In addition, the food processor has allocated to it an additional device that exchanges data with the food processor, and is used to remote control the food processor. This additional device also has a touchscreen, which the user can use to make an input.

As concerns previously known food processors, reference is also to be made to WO 2015/198055 A1 and US 2016/0262422 A1. Known from the latter is to provide a touchscreen with selection options, which belong to specific variables for a preparation item, or to provide sensors that use a code or product image to acquire characteristics of the preparation item.

### SUMMARY OF THE INVENTION

Proceeding from the aforementioned prior art, the object of the invention is to further develop a method for preparing a preparation item by means of a food processor in such a way as to provide the user with additional comfort and in particular to always further optimize preparation success.

In order to achieve the aforementioned object, the invention proposes that, before introducing the preparation item into the preparation vessel, the user hold it in front of the touchscreen with a holding means in such a way that the holding means touches at least a partial area of the touchscreen, wherein a dimension of the held preparation item is ascertained based on the position of the touched partial area on the touchscreen.

This configuration makes it possible to determine a size of the preparation item and set or adjust a preparation step or preparation parameter as a function thereof. As a consequence, not just the type and weight of the preparation item is considered during preparation, for example, so too is the size and/or physical shape of the preparation item. It is here taken into account that a preparation step takes longer when preparing the same kind of essentially spherical preparation item with the same volume instead of a thin, oblong preparation item. The ascertained dimension can in turn be used to infer the external shape of the preparation item, wherein no separate measuring device is required for this determination, but rather an already present touchscreen employed by the user to operate the food processor can be used. For example, depending on the dimension, this makes it possible to also lengthen a cooking time as the preparation item increases in size, so as to maintain a core temperature of the preparation item above a required threshold for successful preparation. The dimension of the preparation item to be determined can be a length and/or a thickness and/or a width of the preparation item, for example, wherein several dimensions are determined one after the other, if needed. The preparation item is held against the touchscreen with a holding means, which holds the preparation item on the one hand and touches at least a partial area of the touchscreen on the other. In an especially simple case, the housing of the food processor and/or the touchscreen has a marking which serves to apply and/or hold a partial area of the holding means or preparation item, for example so that the user applies or holds a partial area of the holding means or preparation item against the marking on the one hand, and presses the holding means against the touchscreen in relation to an opposing end area of the preparation item on the other. At least one area of the touchscreen is here touched, wherein the distance between the marking and contact area indicates the dimension of the preparation item. The procedural step “determine dimension” can either be initiated automatically by the food processor or via a manual instruction of a user, preferably integrated into a recipe sequence.

It is proposed that the ascertained dimension be used to determine a volume of the preparation item. For example, two dimensions of the preparation item can be measured to determine the volume. These two dimensions can be a length and a diameter of the preparation item, for example. In addition, a plurality of other dimensions can be measured to determine the shape of the preparation item, and hence also the volume of the preparation item, as precisely as possible. For example, if the preparation item is one with a repeating shape, e.g., an egg, only a single dimension, for example the height of the egg, can be used to simultaneously infer its diameter and/or volume as well. Depending on the ascertained volume, a preparation parameter, for example a cooking time, can in turn be set for the optimal preparation of the preparation item.

In particular, it is proposed that the ascertained dimension be compared with data stored in a database for various preparation items, and that a preparation parameter of the food processor stored for the dimension of the preparation item be set. The database has reference data for varyingly dimensioned preparation items, which are linked with specific preparation parameters recommended when preparing the preparation item. For example, a table provided for preparing eggs can have rows for varying lengths and/or volumes of the egg and columns for an optimal preparation time. After the user has entered the preparation item into the preparation vessel, the food processor can either automatically set the suggested preparation parameter and start the next preparation step, or the user of the food processor can first request confirmation of the preparation parameter and/or some modification.

For example, a preparation parameter can be a preparation time and/or a preparation temperature. In addition, however, a quantity of liquid to be introduced into the preparation vessel, the type of a liquid, e.g., water or milk, and the like can be set as the preparation parameters for the method, for example.

It is proposed that the user hold the preparation item in front of the touchscreen with his or her hand, wherein the touchscreen is touched by at least one finger, preferably by two or three fingers, of the user while ascertaining the dimension of the preparation item. To this end, the user takes the preparation item in his or her hand, specifically in such a way as to hold it at opposing end areas, for example between two or more fingers. The fingertips holding the preparation item (but preferably not the preparation item itself) here touch the touchscreen, so that the dimension of the preparation item held between the fingers can be inferred from the distance between the touched partial areas of the touchscreen.

It can be alternatively and/or additionally provided that the food processor itself provide a contact surface in the sense of a holding means for the preparation item, so that the preparation item can be held with just one finger, specifically between the contact surface and the finger of the user. The distance between the contact surface and area where the finger touches the touchscreen then corresponds to a dimension of the preparation item.

Since many preparation items, such as eggs, have no even circumferential surface, it is recommended that the user align the respective finger holding the preparation item essentially parallel to a surface normal of the touchscreen and press it against the touchscreen. The user thus uses the finger of his or her hands like a kind of slide gauge to measure a dimension of a preparation item held between the fingers and/or between one finger and a contact surface of the food processor. To this end, for example, the user holds the preparation item at least at two opposing circumferential areas of the preparation item. In terms of an egg, for example, the fingers are here aligned perpendicular to the touchscreen and perpendicular to a rotational axis of the egg, e.g., so that an actual height of the egg can be determined. For example, this makes it possible to determine a length, a width, a diameter or some other dimension of the preparation item. In addition, the user can hold the preparation item by its circumferential surface using a larger number of fingers as well, so that the fingertips at least roughly mark a cross sectional shape of the preparation item on the touchscreen. For example, this in turn makes it possible to infer the type of preparation item and/or the volume of the preparation item with greater precision.

As an alternative to holding the preparation item with the bare hand of the user as described above, it can also be provided that the preparation item be held with a handheld holding device, wherein a holding area of the holding device indicating a dimension of the preparation item is aligned parallel to a surface normal of the touchscreen, and pressed against the touchscreen. In this embodiment, a positioning of the holding areas detected on the touchscreen can be used to infer a dimension of the preparation item. The holding areas thus perform two different functions, specifically holding the preparation item on the one hand, and actuating the touchscreen on the other. The user orients the holding areas of the holding device in such a way that they abut essentially perpendicularly against the touchscreen, so that in the best case there is a 1:1 projection of the respective dimension of the preparation item to be ascertained onto the plane of the touchscreen. The holding device can be provided as an accessory to the food processor, in particular be reversibly connected with the latter.

It is further proposed that the dimension of the preparation item be determined on a touchscreen of the food processor or on the touchscreen of a mobile device having a communications link with the food processor. The user can thus measure the preparation item either on a suitable touchscreen of the food processor, or on a touchscreen of an external device. For example, the external device is connected with the food processor via Bluetooth or a WLAN connection. The external device can be a laptop or tablet computer, for example, which especially preferably has a larger touchscreen than the food processor itself. This makes it possible to also measure preparation items larger than the touchscreen of the food processor itself.

Finally proposed apart from the method described above is also an electrically operated food processor, in particular a cooker-mixer, which has a preparation vessel for holding a preparation item and a touchscreen, wherein the food processor according to the invention is designed for implementing a method described above, wherein a database is provided, and dimensions ascertained using the database can be compared with data stored therein for preparation items, and further a preparation parameter of the food processor stored for the dimension of the preparation item can be set.

In addition, the food processor and an external device can comprise a system, for example which can be used in such a way that a user of the system ascertains a dimension of a preparation item via the touchscreen of the external device, whereupon a preparation parameter of the food processor is then set.

### BRIEF DESCRIPTION OF THE DRAWINGS

The invention will be explained in more detail below based on exemplary embodiments. Shown on:

FIG. 1 is a perspective view from outside of a food processor according to the invention,

FIG. 2 is a food processor while ascertaining a dimension of a preparation item given a manual activation of a touchscreen of the food processor,

FIG. 3 is a food processor while ascertaining a dimension of a preparation item given an activation of a touchscreen of the food processor with a handheld holding device.

### DESCRIPTION OF THE EMBODIMENTS

Depicted and described is a food processor 1, which is here designed as a combined cooker-mixer. The food processor 1 has a preparation vessel 3, with an agitator arranged on the floor of the preparation vessel 3 and not visible in the illustrations. In addition, the preparation vessel 3 can be heated, for example by an electric resistance heater provided on the floor of the preparation vessel 3.

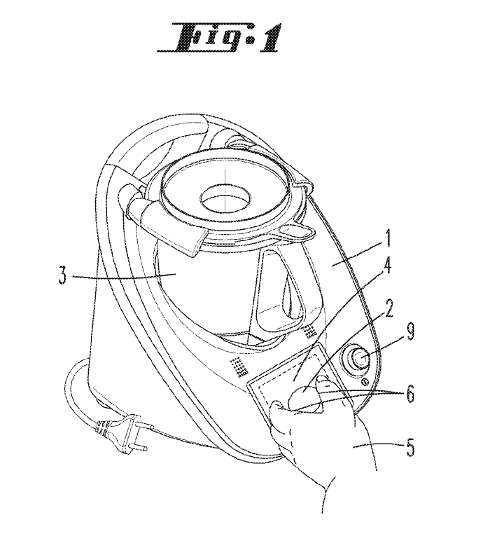

Provided on the control side of the food processor 1 visible on FIG. 1 is a touchscreen 4, along with a rotary switch 9 for turning the food processor 1 on and off, and for setting an agitator speed and the like. In addition, control keys can be provided on the touchscreen 4. The touchscreen 4 is a multi-touch capable touchscreen 4, which can detect several touches at the same time. The touchscreen 4 can further be activated either by the hand of the user, or by an actuating means, for example a stylus or the like.

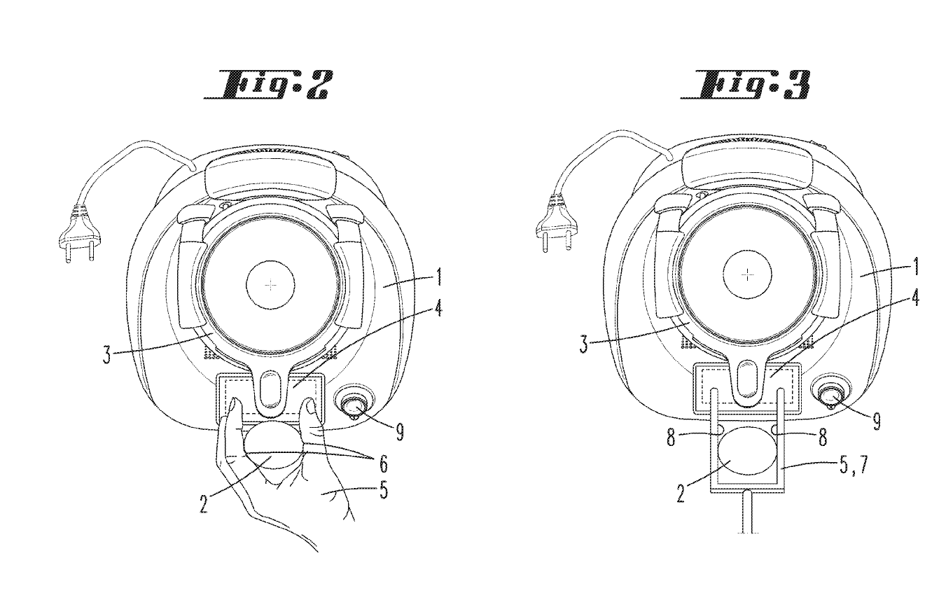

FIG. 2 shows the food processor 1 while ascertaining a dimension of a preparation item 2, here while ascertaining a height (i.e., length) of an egg. In the illustration, the preparation item 2 is held by a holding means 5, here specifically by the hand of the user. The fingers of the hand touch the egg at two opposing circumferential areas 6, which in the depicted case characterize the height of the preparation item 2. The fingers of the hand here point perpendicularly toward the surface of the touchscreen 4, so that the distance between the fingers on the touchscreen 4 corresponds to the height of the preparation item 2.

FIG. 3 shows an alternative embodiment, in which a separate holding device 7 with two holding areas 8 is used while ascertaining a dimension of the preparation item 2. The holding device 7 is designed like a kind of handheld tripod, with the preparation item 2 clamped between its two holding areas 8. The free ends of the holding areas 8 press perpendicularly against the plane of the touchscreen 4, so that the distance between the adjustable holding areas 8, and hence also the distance between the contact areas on the touchscreen 4, corresponds to the height of the preparation item 2.

For example, the invention according to the two shown exemplary embodiments is now realized by the user of the food processor 1 by first searching through a database containing the available recipes via the touchscreen 4 and selecting a desired recipe by touching the touchscreen 4. This recipe consists of a plurality of preparation steps, which sequentially lead to a desired preparation of the preparation items 2 involved. In the example shown here, the recipe encompasses the preparation step of cooking an egg. The recipe is now first automatically or semi-automatically run until the preparation step “cook egg” has been reached. Since the preparation parameters used for cooking the egg depend greatly on the volume of the preparation item 2, it is advantageous to ascertain the dimension of the preparation item 2 before starting the preparation step. In order to determine the dimension of the egg, the user holds it between two fingers of his or her hand, which here serve as the holding means 5. For example, the preparation item 2 can here be held with the thumb and pointer finger, specifically in such a way that the fingers touch two opposing circumferential areas 6 of the egg, here specifically the two tips of the eggs. The user moves his or her hand toward the touchscreen 4 and extends the fingers so that the fingertips touch the touchscreen 4 at the distance of the height (length) of the egg. The procedural step “determine the dimension” can then be initiated either manually by the user actuating a switch of the food processor 1, or automatically as soon as the preparation step “cook egg” is in the queue while running the recipe, and the touchscreen 4 determines a corresponding contact by the holding means 5, i.e., here the hand of the user.

The touchscreen 4 is connected with an evaluation device of the food processor 1, and set up in such a way as to calculate the distance between the contact points on the touchscreen 4 caused by the fingers of the user. The calculated distance is then compared with data stored inside of a database. This database can either be stored on the food processor 1, or on an external device, for example even on a server, which the food processor 1 can access. Based on the current procedural step “cook egg”, it is known that the preparation item 2 is an egg. With respect to the preparation item “egg”, the database links a plurality of possible dimensions with a plurality of preparation parameters. For example, a preparation time of 3 minutes can be allocated to a preparation item 2 with the dimension 4 cm, while a preparation time of 4 minutes is allocated to a preparation item 2 with a dimension of 5 cm. The evaluation device thus compares the ascertained dimension of the preparation item 2 with various reference dimensions, and selects the corresponding preparation parameter when the dimensions match, here a specific cooking time. Depending on the preparation parameter, a preparation instruction is generated for the food processor 1, and the user is prompted to place the preparation item 2 in the preparation vessel 3 (if necessary adding water inside the preparation vessel 3 beforehand). For example, the user then confirms that he or she has placed the preparation item 2 in the preparation vessel 3, whereupon the preparation step “cook egg” is automatically started.

The exemplary embodiment according to FIG. 3 can take place similarly to the procedure according to FIG. 2, but the preparation item 2 is here pressed against the touchscreen 4 by means of the holding device 7. The two holding areas 8 of the holding device 7 clamp the preparation item 2 between them, and preferably doing so in such a way that the distance between the holding areas 8 simultaneously corresponds to the length of the preparation item 2. The touchscreen 4 is designed in such a way as to respond when touched by the holding areas 8 of the holding device 7, so that the dimension of the preparation item 2 can be ascertained as described on FIG. 2.

Even though not shown here on the figures, the holding means 5 or holding device 7 can also be used in conjunction with a touchscreen 4 of an external device, for example of a tablet computer. There is here a data communications link between the external device and food processor 1, so that the ascertained dimension of the preparation item 2 held against the touchscreen 4 can be transmitted to the food processor 1 to continue the procedure.

### REFERENCE LIST

1 Food processor
2 Preparation item
3 Preparation vessel
4 Touchscreen
5 Holding means
6 Circumferential area
7 Holding device
8 Holding area
9 Rotary switch

1: A method for preparing a preparation item (2) by means of an electrically operated food processor (1), wherein a user of the food processor (1) introduces a preparation item (2) into a preparation vessel (3) of the food processor (1), and transmits preparation instructions to a control device of the of the food processor (1) via a touchscreen (4), and wherein the food processor (1), depending on the preparation instructions, automatically performs a preparation step and/or adjusts preparation parameters for preparing the preparation item (2), wherein, before the preparation item (2) is introduced into the preparation vessel (3), the user holds it in front of the touchscreen (4) with a holding means (5) in such a way that the holding means (5) touches at least a partial area of the touchscreen, wherein a dimension of the held preparation item (2) is ascertained based on the position of the touched partial area on the touchscreen (4).

2: The method according to claim 1, wherein a volume of the preparation item (2) is determined based on the ascertained dimension.

3: The method according to claim 1, wherein the ascertained dimension is compared with data stored in a database for various preparation items (2), and a preparation parameter of the food processor (1) stored for the dimension of the preparation item (2) is set.

4: The method according to claim 1, wherein a preparation time and/or a preparation temperature is set as the preparation parameter.

5: The method according to claim 1, wherein the user holds the preparation item (2) in front of the touchscreen (4) with his or her hand, wherein the touchscreen (4) is touched by at least one finger, preferably by two or three fingers, of the user while ascertaining the dimension of the preparation item (2).

6: The method according to claim 5, wherein the user aligns the respective finger holding the preparation item (2) essentially parallel to a surface normal of the touchscreen (4) and presses it against the touchscreen (4).

7: Thee method according to claim 1, wherein the user holds the preparation item (2) at least at two opposing circumferential areas (6) of the preparation item (2).

8: The method according to claim 1, wherein the preparation item (2) is held with a handheld holding device (7), wherein a holding area (8) of the holding device (7) indicating a dimension of the preparation item (2) is aligned parallel to a surface normal of the touchscreen (4), and pressed against the touchscreen (4).

9: The method according to claim 1, wherein the dimension of the preparation item (2) be determined on a touchscreen (4) of the food processor (1) or on the touchscreen (4) of a mobile device having a communications link with the food processor (1).

10: An electrically operated food processor (1), with a preparation vessel (3) for holding a preparation item (2) and with a touchscreen (4), wherein the food processor (1) is designed for implementing a method described above, wherein a database is provided, and dimensions ascertained using the database can be compared with data stored therein for preparation items, and further a preparation parameter of the food processor stored for the dimension of the preparation item can be set.
